(19) United States
(12) Patent Application Publication
(10) Pub. No.: US 2008/0078567 A1
(43) Pub. Date: Apr. 3, 2008

(54) ANTENNA CABLE

(76) Inventors: Donald J. Miller, Roswell, GA (US); Jason Kroh, Villa Rica, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/851,720

(22) Filed: Sep. 7, 2007

Related U.S. Application Data
(60) Provisional application No. 60/824,924, filed on Sep. 8, 2006.

(51) Int. Cl. H01B 11/20

(52) U.S. Cl. 174/70 R; 174/103

(57) ABSTRACT

Embodiments of the present invention are directed to a cable assembly that is adapted to be connected to an antenna and a base unit. The cable assembly may be relatively flat with shielding and structures to reduce ground currents or other interference. Embodiments of the cable assembly include at least two coaxial cables for transmit and receive signals that are separated to reduce crosstalk or other interference. The cable may also include one or more inner cables, such as differential or switching pairs, between the two coaxial cables to provide cables for control, power, switching, or other functions. The inner cables may be positioned in parallel to each other and to each of the coaxial cables. In some embodiments, the inner cables include a first inner cable located at a first end of the inner cables and a second inner cable located at a second end of the inner cables. One coaxial cable may be positioned adjacent and parallel to the first inner cable, which the other coaxial cable may be positioned adjacent and parallel to the second inner cable.

### CROSS REFERENCE TO RELATED APPLICATIONS

This application claims priority to U.S. Provisional Patent Application No. 60/824,924, titled “Antenna Cable,” filed Sep. 8, 2006, the entire contents of which is incorporated herein by reference.

This application is related to U.S. patent application Ser. No. 11/668,601, titled “Cable Assembly for a Coupling Loop,” filed Jan. 1, 2007, which is a continuation of U.S. patent application Ser. No. 11/479,527, filed Jun. 30, 2006, which claims the benefit of U.S. Provisional Application No. 60/697,867, filed Jul. 8, 2005, and is a continuation-in-part of U.S. patent application Ser. No. 11/105,294, filed Apr. 13, 2005, which claims the benefit of U.S. Provisional Patent Application No. 60/623,959, filed Nov. 1, 2004; U.S. Provisional Application No. 60/697,878, filed Jul. 8, 2005 and U.S. Provisional Application No. 60/707,094, filed Aug. 10, 2005, the contents of each of which is incorporated herein by this reference (and which are referred to herein collectively as the “Related Applications”).

### FIELD OF THE INVENTION

This invention relates generally to a antenna cable for connecting a base unit and an antenna, and in particular to a relatively flat antenna cable.

### BACKGROUND OF THE INVENTION

Wireless sensors can be implanted within the body and used to monitor physical conditions, such as pressure or temperature. These sensors can be used to monitor physical conditions within the heart or an abdominal aneurysm. An abdominal aortic aneurysm (AAA) is a dilatation and weakening of the abdominal aorta that can lead to aortic rupture and sudden death. In the case of a repaired abdominal aneurysm, a sensor can be used to monitor pressure within the aneurysm sac to determine whether the intervention is leaking. The standard treatment for AAAs employs the use of stent-grafts that are implanted via endovascular techniques. However, a significant problem that has emerged with these stent-grafts for AAAs is acute and late leaks of blood into the aneurysm's sac. Currently, following stent-graft implantation, patients are subjected to periodic evaluation via abdominal CT (Computed Tomography) with IV contrast to identify the potential presence of stent-graft leaks. This is an expensive, risky procedure that lacks appropriate sensitivity to detect small leaks.

Typically, the sensors utilize an inductive-capacitive (“LC”) resonant circuit with a variable capacitor. The capacitance of the circuit varies with the pressure of the environment in which the sensor is located and thus, the resonant frequency of the circuit varies as the pressure varies. Thus, the resonant frequency of the circuit can be used to calculate pressure.

Ideally, the resonant frequency is determined using a non-invasive procedure. The signal from the sensor is weak relative to the signal used to energize the sensor, but is the same frequency and dissipates quickly. In some cases, the difference between the signals is on the order of 150 dB and the sensor signal is sampled approximately 35 nanoseconds after the energizing signal is turned off. In order to communicate with the sensor, the system uses a base unit and an antenna that are connected by a cable assembly. For example, a person with an implanted sensor may lie, sit, or stand close to or in contact with a flexible antenna or other antenna. Due to the unique characteristics of the transmit and receive signals the antenna and the cable assembly need to isolate the energizing signal and the sensor signal, support the necessary sampling speed, and support a relatively large bandwidth.

Conventional cable assemblies can be relatively bulky, heavy, expensive, and, in some applications of the antenna, unworkable. For example, relatively large ferrite beads used in some cable assemblies may prevent the use of the cable in some configurations. Conventional cable assemblies may also be susceptible to crosstalk or other interference between the cables. Accordingly, a need exists for an antenna cable assembly that reduces signal interference while providing a more workable cable system.

### BRIEF SUMMARY OF THE INVENTION

Aspects and embodiments of the present invention provide an antenna cable assembly between the antenna and a base unit that includes a relatively flat cable with shielding and structures to reduce ground currents or other interference. Embodiments of the cable assembly include at least two coaxial cables for transmit and receive signals that are separated to reduce crosstalk or other interference. The cable may also include one or more inner cables, such as differential or switching pairs, between the two coaxial cables to provide cables for control, power, switching, or other functions.

The inner cables may be positioned in parallel to each other and to each of the coaxial cables. In some embodiments, the inner cables include a first inner cable located at a first end of the inner cables and a second inner cable located at a second end of the inner cables. One coaxial cable may be positioned adjacent and parallel to the first inner cable. The other coaxial cable may be positioned adjacent and parallel to the second inner cable.

In some embodiments, the inner cables include an internal signal cable shield to prevent or reduce external interference. The inner cables and coaxial cable may be cased in an outer shielding to prevent or reduce external interference. Shields such as ferrite beads may be connected to at least some sub-component cables at or near the end of a cable to (1) reduce interference from ground currents or other sources; (2) assist the return signals associated with the sub-component coaxial cables to follow the coax shield instead of an undesirable alternate path; and (3) insure that differential pairs act relatively more ideally, such as with their return currents being relatively more ideally contained within the differential pair.

These embodiments are mentioned not to limit or define the invention, but to provide examples of embodiments of the invention to aid understanding thereof. Embodiments are discussed in the Detailed Description, and further description of the invention is provided there. Advantages offered by the various embodiments of the present invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 is a block diagram of an exemplary system for communicating with a wireless sensor in accordance with one embodiment of the present invention;

FIG. 2 shows a cross-sectional view of a cable assembly according to one embodiment of the present invention;

FIG. 3 shows a cross-sectional view of a cable assembly according to another embodiment of the present invention; and

FIG. 4 shows a side view of a cable assembly according to one embodiment of the invention.

### DETAILED DESCRIPTION OF THE INVENTION

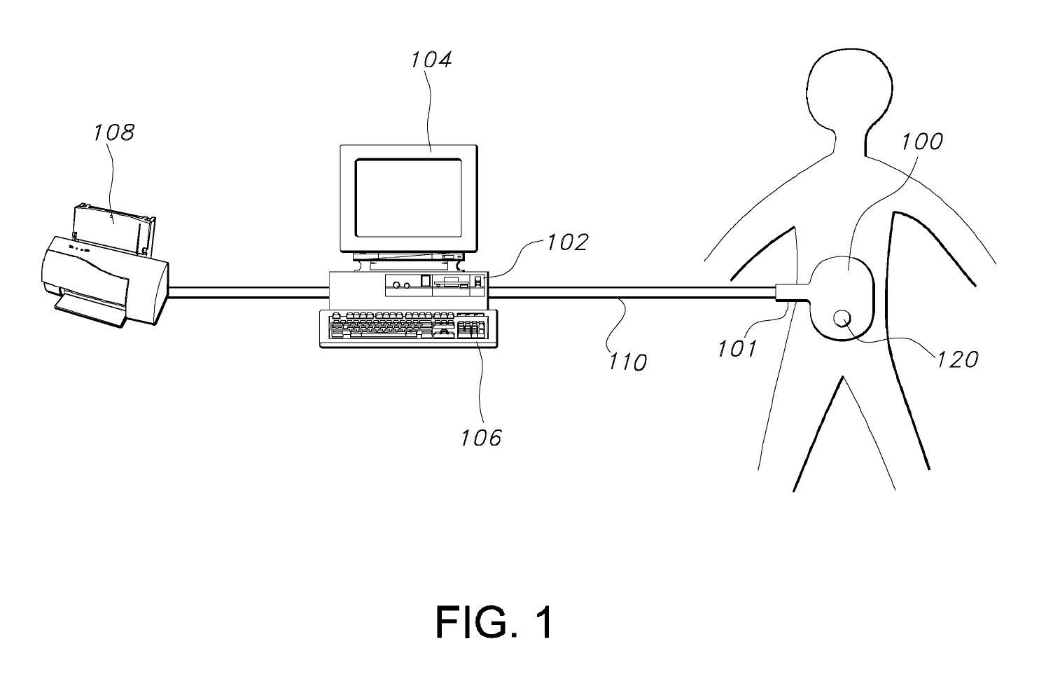

As described in the Related Applications, a cable assembly connects the antenna to a base unit in a system for communicating with a wireless sensor implanted within a body. FIG. 1 illustrates one embodiment of such a system. The system includes an antenna, such as coupling loop 100, a base unit 102, a display device 104 and an input device 106. Examples of input device 106 can include a keyboard, a mouse, or otherwise. The display device 104 may also include input device 106, such as a touch screen. The base unit 102 can include an RF amplifier, a receiver, and signal processing circuitry.

The display device 104 and the input device 106 are used in connection with the user interface for the system. In the embodiment illustrated in FIG. 1, the display device 104 and the input device 106 are connected to the base unit 102. In this embodiment, the base unit 102 also provides conventional computing functions. In other embodiments, the base unit 102 can be connected to a conventional computer, such as a laptop, via a communications link, such as an RS-232 link. If a separate computer is used, then the display device 104 and the input devices 106 associated with the computer can be used to provide the user interface. In one embodiment, LABVIEW software is used to provide the user interface, as well as to provide graphics, store and organize data and perform calculations for calibration and normalization. The user interface records and displays patient data and guides the user through surgical and follow-up procedures. An optional printer 108 is connected to the base unit and can be used to print out patient data or other types of information. As will be apparent to those skilled in the art other configurations of the system, as well as additional or fewer components can be utilized with the invention.

The base unit 102 can be connected to the coupling loop 100 via cable assembly 110. The cable assembly 110 may to adapted to carry signals between the base unit 102 and coupling loop 100. Examples of such signals include control signals, energizing signals, sensor return signals, or otherwise. The coupling loop 100 charges the sensor 120 when the base unit 102 sends signals via cable assembly 100 to the coupling loop 100. The coupling loop 100 then couples signals from the sensor 120 into the receiver. In some embodiments, the coupling loop 100 can include switching and filtering circuitry enclosed within a shielded box 101. PIN diode switching inside the loop assembly is used to provide isolation between the energizing phase and the receive phase by opening the receive path PIN diodes during the period when the energizing signal is transmitted to the sensor 120, and opening the energizing path PIN diodes during the period when the sensor signal is received from the sensor 120. In some embodiments the two separate loops may be provided. One loop may be used to transmit an energizing signal, while the second loop may be a coupling loop to receive the sensor signal.

FIG. 1 illustrates the system communicating with a sensor 120 implanted in a patient. Each sensor is associated with a number of calibration parameters, such as frequency, offset, and slope. The system is used in two environments: 1) the operating room during implant and 2) the physician's office during follow-up examinations. During implant the system is used to record at least two measurements. The first measurement is taken during introduction of the sensor for calibration and the second measurement is taken after placement for functional verification of the stent graft. The measurements can be taken by placing the coupling loop either on or adjacent to the patient's back or the patient's stomach for a sensor that measures properties associated with an abdominal aneurysm. For other types of measurements, the coupling loop may be placed in other locations. For example, to measure properties associated with the heart, the coupling loop can be placed on the patient's back or the patient's chest.

The system communicates with the implanted sensor to determine the resonant frequency of the sensor. As described in more detail in the patent documents referenced in the Background section, a sensor typically includes an inductive-capacitive (“LC”) resonant circuit having a variable capacitor. The distance between the plates of the variable capacitor varies as the surrounding pressure varies. Thus, the resonant frequency of the circuit can be used to determine the pressure.

The system energizes the sensor with an RF burst. The energizing signal is a low duty cycle, gated burst of RF energy of a predetermined frequency or set of frequencies and a predetermined amplitude. Typically, the duty cycle of the energizing signal ranges from 0.1% to 50%. In one embodiment, the system energizes the sensor with a 30-37.5 MHz fundamental signal at a pulse repetition rate of 100 kHz with a duty cycle of 20%. The energizing signal is coupled to the sensor via the coupling loop. This signal induces a current in the sensor which has maximum amplitude at the resonant frequency of the sensor. During this time, the sensor charges exponentially to a steady-state amplitude that is proportional to the coupling efficiency, distance between the sensor and loop, and the RF power. When the coupling loop is coupling energy at or near the resonant frequency of the sensor, the amplitude of the sensor return is maximized, and the phase of the sensor return will be close to zero degrees with respect to the energizing phase. The sensor return signal is processed via phase-locked-loops to steer the frequency and phase of the next energizing pulse.

Cable assemblies according to various embodiments of the present invention may include coaxial cables, differential or switching pairs or other types of cables for allowing transmit and receive signals, control signals, and other signals to travel between the antenna and base unit. In some embodiments, the cable assembly can include two coaxial cables. One coaxial cable may be used to carry transmit signals, while the other coaxial cable may be used to carry receive signals. The two coaxial are located as far away as possible from each other in the cable assembly to reduce interference with each other. Shields, such as ferrite beads are used to reduce interference from ground currents or other sources. The present invention provides the advantages described in the Related Applications but also provides a relatively flat cable assembly with additional advantages. The present invention differs from the cable described in the Related Applications in that it is relatively flat and light, whereas the cable described in the Related Applications has a circular cross-section and greater weight. For example, the coaxial cables and inner cables may be positioned in an essentially flat plane relative to each other.

Certain aspects and embodiments of the present invention provide an antenna cable assembly adapted to be incorporated in an implanted sensor data acquisition system that is relatively flat and includes multiple cables capable of carrying signals to and from the antenna and a separate device such as a base unit. Certain exemplary embodiments of the present invention provide a ribbon cable with a coaxial cable on each end of the ribbon cable and a shield or other protective cover around the ribbon and coaxial cables. The cable assembly can include various conductor cables such as coaxial cables for transmit and receive signals and coaxial cable and differential or switching pairs for power, control, switching, or any other type of communication. Embodiments of the cable assembly provide a relatively flat cable, such as by aligning the various cables side-by-side or in an essentially flat plane, that is flexible in at least one direction. Other embodiments of the cable assembly may be flexible in multiple directions.

Certain embodiments of the present invention provide a cable assembly that separates the transmit and receive cables, such as by locating the transmit cable on one end and the receive cable on the other end of the cable assembly. To reduce interference between the two cables, the distance between the energizing signal traveling on the transmit cable and the sensor signal traveling on the receive cable is maximized. Relatively small ferrite beads may surround the ends of one or more of the cables, or pairs of cables, to assist in obtaining signal balance and to insure that the signals follow the correct path, such as the coaxial cable shield.

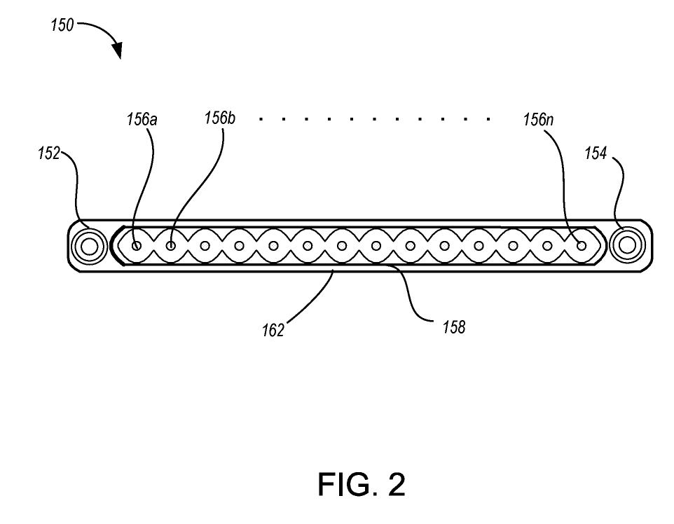

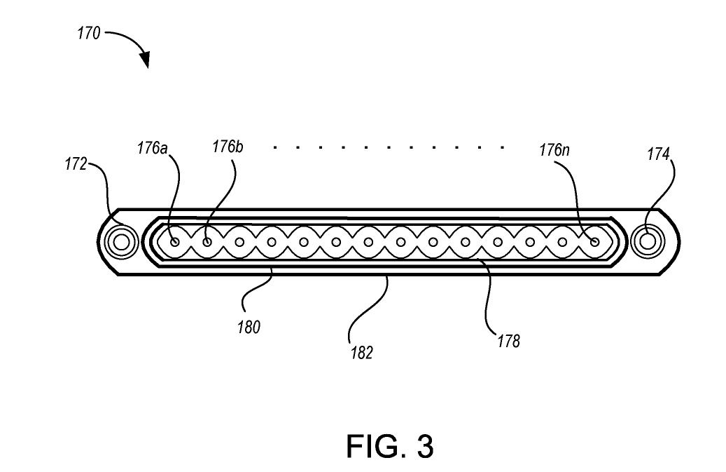

FIGS. 2 and 3 illustrate cross-sectional views of a cable assembly according to certain embodiments of the present invention. The cable assembly 150 in FIG. 2 includes two coaxial cables 152, 154 and multiple inner cables 156a-n located side-by-side, such as in parallel, with each other. The distance between coaxial cable 152 and coaxial cable 154 is maximized by locating them in parallel with each other and positioning the inner cables 156a-n between the two coaxial cables 152, 154 and also locating the inner cables 156a-n in parallel to coaxial cables 152, 154. For example, coaxial cable 152 may be positioned adjacent, and parallel, to a first inner cable 156a. Coaxial cable 154 may be positioned adjacent, and parallel, to a second inner cable 156n that is located as far from the first inner cable 156a as possible. Transmit signals, such as energizing signals from the base unit, may travel on coaxial cable 152 and receive signals, such as sensor signals from the implanted sensor, may travel on coaxial cable 154. The coaxial cables 152, 154 and inner cables 156a-n may be positioned side-by-side in an essentially planar configuration. The coaxial cables 152, 154 are located at the ends of the cable assembly 150, separated by the inner cables 156a-n, to maximize the distance between the transmit cable and receive cable and reduce and/or prevent interference between the transmit and receive cables. In one embodiment of the invention, the coaxial cables 152, 154 are Alpha 9178B cables provided by Alpha Wire Company, Elizabeth, N.J.

Inner cables 156a-n may allow a variety of signals to travel between the antenna and base unit. For example, one or more inner cables 156a-n may provide power to the antenna and one or more inner cables 156a-n may carry control or status signals. In one embodiment, the inner cables 156a-n may be implemented using an 0.05 inch pitch ribbon cable with fourteen cables. Examples of ribbon cable that may be used include 3M 3517/14 shielded ribbon cable provided by 3M Corporation, St. Paul, Minn. The cable assembly 150 may also include an outer casing 162 that substantially surrounds the coaxial cables 152, 154 and the inner cables 156a-n. For example, the outer casing 162 may prevent signals or other electromagnetic emissions from outside the outer casing 162 from affecting the signals traveling the coaxial cables 152, 154 and inner cables 156a-n. In some embodiments, the cable assembly 150 may include an internal cable shield 158 that substantially surrounds the inner cables 156a-n. The internal cable shield 158 may be a metallic shield, such as copper foil, and/or a braided metallic material. The internal cable shield 158 may prevent signals traveling the coaxial cables 152, 154 from interfering with signals traveling the inner cables 156a-n or signals traveling the inner cables from interfering with signals traveling the coaxial cables 152, 154.

FIG. 3 shows a cross-sectional view of another embodiment of a cable assembly 170. The cable assembly 170 may include two coaxial cables 172, 174 and inner cables 176a-n located in parallel between the coaxial cables 172, 174. For example, the cable assembly may have a substantially flat configuration with the coaxial cables 172, 174 and inner cables 176a-n located in a substantially planar configuration relative to each other. The two coaxial cables 172, 174 are spaced as far apart from each other as possible. For example, coaxial cable 172 is located adjacent to inner cable 176a, while coaxial 174 is located adjacent to inner cable 176n. The cable assembly 170 may also include an inner casing 180 surrounding an internal cable shield 178. An outer casing 182 may surround the coaxial cables 172, 174, inner cables 176a-n, inner cable shield 178, and, in some embodiments, the inner casing 180 to protect the coaxial cables 172, 174 and inner cables 176 from physical damage and reduce or prevent interference from external sources emitting radio frequency waves.

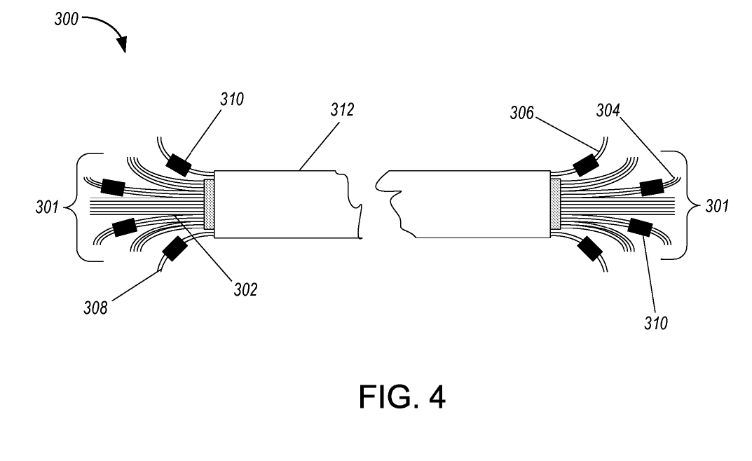

FIG. 4 illustrates one embodiment of a cable assembly 300 and cable assembly ends 302, 304. The cable assembly 300 includes coaxial cables 306, 308 and a plurality of inner cables 301. An outer casing 312 can substantially surround the coaxial cables 306, 308 and inner cables 301. Each of the coaxial cables 306, 308 and each of the inner cables 301 can include two ends extending from the outer casing 312. The ends can be connected to an antenna, shielded box, and/or base unit. Ferrite beads 310 are attached to one or both ends of one or more inner cables 301, for example to differential or switching pairs, to assist in balancing signals. Ferrite beads 310 can also be attached to one or more ends of the coaxial cables 306, 308 to assist return signals in following the coax shield and not another path. IN some embodiments a ferrite bead is attached to each end of all cables in the cable assembly 300. The ferrite beads 310 may be attached to the coaxial cables 306, 308 and/or inner cables 301 between the outer casing 312 and the ends that can be connected to an antenna, shielded box, and/or base unit. An example of ferrite beads 310 that may be used include J. W. Miller FB73-287 provided by Bourns, Inc., Riverside, Calif.

As described above, the cable assembly 300 can connect to connectors at the antenna and/or base unit. In other embodiments, the cable assembly 300 can connect to any type of connector at the antenna and/or base unit. Examples of such connectors may include multi-pin connectors and serial connectors. The cable assembly 300 may also be adapted to connect to a flat antenna either directly or via a low profile connector. For example, the plurality of inner cables 301 may be terminated in a 0.1 inch pitch dual-row ribbon cable connector, such as the AMP 746285 series manufactured by Amp, Incorporated of Harrisburg, Pa. The coaxial cables 306, 308 can be terminated into any of a coax connectors, such as SMA, OSMT, or mini-RCA.

Embodiments of the present invention provide a cable assembly that is relatively flexible and light weight and is adapted to connect to an antenna and base unit via connectors. The cable assembly can provide a plurality of cables to send and receive information between the antenna and base unit and include one or more casings to protect the cables and signals traveling the cables from physical damage or signal interference. Ferrite beads are attached to the ends of the cables of the cable assembly to further protect and guide signals. Embodiments of the cable assembly may also reduce the risk of damage to the cables at the connector points by being relatively light weight and decreasing the stress on the cable assembly at the connector points.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope.

What is claimed is:

1. A cable, comprising:
a first coaxial cable;
a second coaxial cable located in parallel to the first coaxial cable;
a plurality of inner cables positioned between the first coaxial cable and the second coaxial cable, each of the plurality of inner cables being positioned in parallel to each other, the first coaxial cable and the second coaxial cable;
an outer casing surrounding the first coaxial cable, the second coaxial cable and the plurality of inner cables; and
wherein the first coaxial cable, the second coaxial cable, and the plurality of inner cables are positioned essentially within the same plane, the first coaxial cable and the second coaxial cable being positioned on opposites sides of the plurality of inner cables, the first coaxial cable and the second coaxial cable being adapted to connect to an antenna and a base unit.

2. The cable of claim 1, wherein each of the first coaxial cable, second coaxial cable, and plurality of inner cables comprises a first end and a second end, the cable further comprising a shield attached to an end of at least one of:
the first coaxial cable;
the second coaxial cable; and
an inner cable.

3. The cable of claim 2, wherein the shield is a ferrite bead.

4. The cable of claim 3, wherein the ferrite bead is attached to an end of a plurality of inner cables.

5. The cable of claim 1, wherein the plurality of inner cables is a ribbon cable.

6. The cable of claim 1, further comprising an inner cable shield surrounding the plurality of inner cables.

7. The cable of claim 6, further comprising an inner casing surrounding the plurality of inner cables and the inner cable shield, wherein the outer casing surrounds the inner casing and inner cable shield.

8. A cable comprising:
a first coaxial cable;
a second coaxial cable located in parallel to the first coaxial cable;
a plurality of inner cables located in essentially the same plane as the first coaxial cable and the second coaxial cable, the plurality of inner cables comprising a first inner cable and a second inner cable, each of the plurality of inner cables being located in parallel to each other, the first inner cable being located at a first end of the plurality of inner cables, the second inner cable being located at a second end of the plurality of inner cables;
an outer casing surrounding the first coaxial cable, the second coaxial cable and the plurality of inner cables;
wherein the first coaxial cable is adjacent to the first inner cable and the second coaxial cable is adjacent to the second inner cable; and
wherein the first coaxial cable and the second coaxial cable are adapted to connect to an antenna and a base unit.

9. The cable of claim 8, wherein each of the first coaxial cable, second coaxial cable, and plurality of inner cables comprises a first end and a second end, the cable further comprising a shield connected to an end of at least one of:
the first coaxial cable;
the second coaxial cable; and
an inner cable.

10. The cable of claim 9, wherein the shield is a ferrite bead.

11. The cable of claim 10, wherein the ferrite bead is connected to a plurality of inner cables.

12. The cable of claim 8, wherein the plurality of inner cables is a ribbon cable.

13. The cable of claim 8, further comprising an inner cable shield surrounding the plurality of inner cables.

14. The cable of claim 13, further comprising an inner casing surrounding the plurality of inner cables and the inner cable shield, wherein the outer casing surrounds the inner casing and inner cable shield.
